(19) United States
(12) Patent Application Publication
(10) Pub. No.: US 2019/0233959 A1
(43) Pub. Date: Aug. 1, 2019

(54) EXTRACTION AND RECOVERY OF LITHIUM FROM BRINE

(71) Applicant: MINEXTECH LLC, Oro Valley, AZ (US)

(72) Inventor: William D. Ernt, Mesa, AZ (US)

(21) Appl. No.: 15/881,463

(22) Filed: Jan. 26, 2018

(51) Int. Cl. C25C 1/02; B01D 17/02

(52) U.S. Cl. CPC C25C 1/02; B01D 17/0217

(57) ABSTRACT

Provided is a liquid-liquid extraction process and apparatus for recovering an alkali or alkaline earth metal or other metal from a source solution such as geothermal brine.

### FIELD OF THE INVENTION

This invention relates generally to the field of recovery of metals from process solutions. The invention has particular utility for use in connection with recovery of alkali and alkaline earth metals such as lithium from geothermal brines and will be described in connection with such utility, although other utilities are contemplated.

### DESCRIPTION OF RELATED ART

Geothermal brines normally contain various metal ions, particularly alkali and alkaline earth metals, in varying concentrations. Recovery of these metals is important to the chemical and pharmaceutical industry. Lithium, in particular, is an important high value alkali metal having an increasing demand for its utility in storage batteries.

Several processes currently exist for recovery of lithium from lithium-containing brines. However, current extraction methods are expensive and time consuming, and the resulting material produced by existing processes typically is not sufficiently pure for use in lithium ion batteries, or pharmaceutical grade lithium without costly additional purification steps.

### SUMMARY OF THE INVENTION

The present invention provides a system, i.e., method and apparatus for extracting lithium from aqueous brine. More particularly, the invention involves a liquid-liquid extraction and apparatus method, which comprises mixing an aqueous immiscible liquid ion exchange reagent having a capacity to selectively extract lithium, with the aqueous brine, in a liquid-liquid solvent extraction scheme. Several liquid ion exchange reagents that are immiscible with water and capable of extracting lithium are known and advantageously may be employed in the present invention. The liquid ion exchange reagents include but are not limited to tert-butyl benzo-12-crown-4 ether in a short chain linear polymer (SCP), halogenated β-diketones, preferably a chlorinated β-diketone, or a Lewis-based ion exchange such as an amine or oxime such as described in U.S. Pat. Nos. 3,479,147, 3,793,433 and 3,307,922, which are given as exemplary. Particularly preferred are tert-butyl benzo-12-crown-4 ether in a short chain linear polymer (SCP) and the chlorinated β-diketone.

In terms of liquid-liquid extraction apparatus useful in the scheme, the apparatus preferably comprises a liquid-liquid extraction apparatus such as described in U.S. Pat. No. 5,466,375, incorporated herein by reference. A particularly preferred apparatus is described in our co-pending U.S. application Ser. No. 15/051,352, tiled Feb. 23, 2016, and will be described in connection with such embodiment, although the invention is not limited to the use of such apparatus.

In one aspect of the invention there is provided a method for extracting an alkali or alkaline earth metal or other metal from a source of an aqueous brine containing said alkali or alkaline earth metal or other metal comprising the steps of: feeding the aqueous brine and an immiscible liquid ion exchange reagent having a capacity to selectively extract said alkali or alkaline earth metal or other metal to a first mixing vessel, wherein the mixing vessel comprises a first elongate housing having an inlet adjacent one end and an outlet adjacent the other end, and a permeable body coaxially disposed within the housing; passing the mixture from the first mixing vessel to a first centrifuge wherein the mixture is separated into a light organic phase which is mixed in a second mixer with lean electrolyte from a downstream electrowinning stage, and a heavy aqueous raffinate phase which is returned to the source; and passing the mixture from the second mixer to a second centrifuge where the mixture is separated into an aqueous raffinate phase, which is passed to an electrowinning cell wherein the alkali or alkaline earth metal or other metal is removed from the aqueous raffinate by electrowinning, and a lean electrolyte which is passed to the second mixer.

In one aspect of the invention the first and the second mixers have mixing channels substantially in the shape of a helix.

In another aspect of the invention, the first and second mixers include internal baffles formed of a series of elongated segments formed end-to-end.

In yet another aspect of the invention, the permeable body has pores in the range of 0.2 to 400 microns, preferably 20 to 200 microns, more preferably 60 to 100 microns.

In still yet another aspect of the invention, the permeable body comprises an elongate cylinder, in shape.

In a further aspect of the invention, the first and second mixers are sized and shaped to provide a travel or residence time between the first and second mixing devices and the first and second centrifuges of 5-120 seconds, preferably 20-60 seconds, more preferably 35-45 seconds.

In a preferred aspect of the invention, the aqueous or process solution comprises lithium and the immiscible liquid ion exchange reagent comprises tert-butyl benzo-12-crown-4 ether in a short chain linear polymer (SCP), a halogenated β-diketone or an ion exchange, more preferably an amine or an oxime ion exchange, or a hydroxyl oxime ion exchange.

In another aspect of the invention the aqueous raffinate from the first centrifuge is returned to the source.

In one aspect of the invention, the source comprises a geothermal brine, a brine from a mining source, an oil field brine, a relict hydrothermal brine, or an intercontinental salt lake.

Still yet another aspect of the invention includes the step of prefiltering the brine to remove silica.

In still yet another aspect of the invention, the source comprises a geothermal reservoir well and the aqueous raffinate is returned to the geothermal reservoir well by injection into the well

### BRIEF DESCRIPTION OF THE DRAWINGS

Further features and advantages of the present invention will be seen from the following detailed description, taken in conjunction with the accompanying drawings, wherein like numerals depict like parts, and wherein:

FIG. 1 is flow diagram of a system for the hydrometallurgical production of a metal such as a geothermal brine containing lithium in accordance with one aspect the present invention;

FIG. 1A is a side elevation view, in cross section, showing details of an apparatus for dispersing an organic fluid such as kerosene into an aqueous-based solution in accordance with another aspect of the present invention;

FIG. 2 is a side elevational view, in cross section, of a centrifugal contractor-separator employed in accordance with the present invention;

FIG. 2A is a cross-sectional view of the rotating cylinder portion of the centrifugal contractor—separator of FIG. 2; and

FIG. 3 is a flow diagram, similar to FIG. 1, of an alternative system for the hydrometallurgical production of a metal such as lithium from a in accordance with the present invention.

### DETAILED DESCRIPTION OF THE INVENTION

The invention will now be described in connection with the separation of lithium from a geothermal brine.

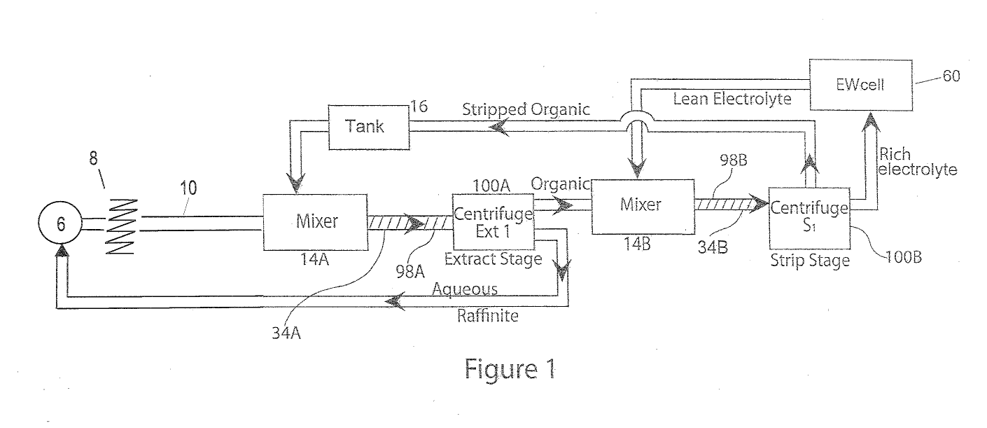

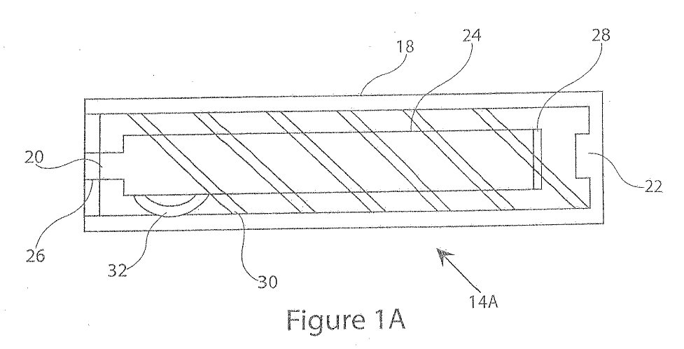

Referring to FIGS. 1 and 1A, the method starts with subjecting a lithium-containing brine solution from a geothermal brine source 6 to a silica removal filter step 8 to produce a silica-lean lithium containing brine solution. The silica lean lithium containing brine solution is then fed to a first mixing vessel 14A where the lithium containing brine solution is mixed with an organic liquid ion exchange reagent such as a tert-butyl benzo-12-crown-4 ether in a short chain linear polymer (SCP) ion exchange in a high flash diluent, e.g. a liquid hydrocarbon mixture such as kerosine, having a flash point above about 67° C. (as measured by ASTM Test Standard D56), supplied from tank 16. Referring in particular to FIG. 1A, mixing vessel 14A comprises an elongate cylindrical housing 18 having an inlet 20 at on end, and an outlet 22 at the other end. A permeable body 24 in the shape of a cylindrical tube is coaxially disposed within the cylindrical housing 18. However, housing 18 and permeable body 24 need not be cylindrical—they may be square, or rectangular or have other geometric shapes in cross-section. The permeable body 24 is connected to the housing inlet 20 at one end 26, and a disc 28 closes the end of permeable body 24 adjacent the housing outlet 22.

The outer wall of permeable body 24 is spaced from the interior wall of housing 18. A helical baffle 30 is located within the annular space between the outer wall of permeable body 24 and the inner wall of housing 18. Baffle 30 may be a continuous elongated helical strip or formed as a series of segments. Mixing vessel 14A also has a lateral inlet 32 adjacent the inlet 20 end.

Permeable body 24 can be made of permeable or porous metal, and is filled with loosely packed finely divided media or fits such as powdered metal particles or ceramic particles. Various permeable and porous metals are available commercially from a variety of vendors including Mott Metallurgical Corporation of Farmington, Conn. The permeable or porous metal used in this invention preferably has substantially uniform pore sizes, or at least most of the pores are within an acceptable range for the intended purpose, and typically are in the range of 0.2 to 400 microns, preferably 20 to 200 microns, more particularly 60 to 100 microns. The porous media or fits should be inert to the liquids being handled. For example, the media or frits can be made of particles of ceramic, or stainless steel, Nickel 200, Monel® 400, Inconel® 600, Hastelloy® C276, Alloy 20, gold, platinum, silver, and titanium. As will be described below, the media or fits, by their nature, cause the droplets of the organic solvent to finally divide, dispersing fine droplets on the outer surface of the permeable body 24, where they are picked up by the aqueous brine solution. In other words, the solution (either the aqueous phase or the organic) which passes through the permeable body 24 is dispersed into the continuous phase liquid passing through the annular space.

In use, the organic liquid ion exchange reagent in a high flash point diluent is introduced through inlet 20 into the interior of permeable body 24. Aqueous brine solution is introduced into the interior of mixing vessel 14A through lateral inlet 32, into the space between the outer wall of permeable body 24 and the inner wall of mixing vessel 14A. The organic liquid ion exchange reagent is forced through the permeable body 24 and emerges from the permeable body in the form of a fine organic liquid extractant droplets where the droplets are picked up by the flowing aqueous brine solution, forming a dispersion of organic droplets in the aqueous brine solution. The aqueous brine solution preferably is flowed under turbulent conditions so that the droplets of the organic liquid ion exchange reagent are quickly dispersed before having an opportunity to coalesce. The liquid ion exchange reagent, which is substantially immiscible with the aqueous brine solution, extracts lithium from the aqueous brine solution, and emerges from the mixing vessel 14A via outlet 22.

Alternatively, the aqueous brine solution may be introduced into the interior of permeable body 24, and the organic liquid extractant introduced into the interior of the mixing vessel 14A through lateral inlet 32, into the space between the outer wall of permeable body 24 and the inner wall of mixing vessel 14A. In such case, the aqueous brine solution is forced through the permeable body 24, and emerges from the permeable body in the farm of fine droplets, which are picked up by the flowing organic liquid ion exchange reagent, forming a dispersion of aqueous droplets in the organic phase.

The solution emerging from outlet 22 is passed via conduit 34A to an extract stage centrifugal separator 100A as will be described in detail below. Conduit 34A includes inline baffles shown phantom as 98A for maintaining the fluid in a mixed condition. Conduit 34A is sized and shaped relative to the flow of fluid from mixing vessel 14A to provide a travel or residence time sufficient to permit substantial mass transfer of lithium in the aqueous solution to the liquid ion exchange reagent. Ordinarily, a residence time of 5-120 seconds, preferably 20-60 seconds, more preferably 35-45 seconds, is sufficient before the fluid is introduced into a centrifugal separator 100A. Alternatively, one or more loops may be included in the conduit 34A, or the cross sectional size of the conduit 34A increased so that the flow from mixing vessel 14A is controlled to within the target residence time of 5-120 seconds.

As will be described below, centrifuge separator 100A creates two exit streams-a light phase (organic) and a heavy phase (aqueous raffinate). The aqueous raffinate is recycled to the brine feed to dissolve more lithium. The organic phase liquid ion exchange reagent exiting the centrifuge 100A is transferred to another mixing vessel 14B, similar to mixing vessel 14A, where it is mixed with lean electrolyte from the electrowinning stage 60 as will be discussed below. As before, the organic liquid ion exchange reagent is forced through the permeable body 24 contained in mixing vessel 14B, and emerges from the permeable body in the form of a fine organic liquid ion exchange reagent droplets where the droplets are picked up by the flowing electrolyte, forming a dispersion of liquid ion exchange reagent droplets in the electrolyte. As before, the electrolyte preferably is flowed under turbulent conditions so that the droplets of the organic liquid ion exchange reagent are quickly dispersed before having an opportunity to coalesce. The electrolyte or stripping solution, which is substantially immiscible with the organic liquid ion exchange reagent removes (strips) lithium from the organic liquid ion exchange reagent and emerges from the mixing vessel 14B, where it is passed via conduit 34B which also contains inline baffles shown in phantom as 98B, similar to conduit 34A, for maintaining the fluid in a mixed condition. As before, conduit 34B is sized and shaped relative to the flow of the fluid from mixing vessel 14A to provide a travel or residence time sufficient to permit substantial mass transfer of lithium in the aqueous solution to the organic liquid ion exchange reagent. As with mixer 14A, mixer 14B can be operated where the aqueous stripping solution passes through the permeable body 24 and is dispersed into the organic phase passing through the annular space. The fluid then passed to a second strip stage, centrifuge 100B which is similar in construction to centrifuge 100A as will be described in detail below, and in which a light organic liquid ion exchange reagent phase is partially stripped of lithium and returned to tank 16, and a rich lithium electrolyte phase is passed to an electrowinning cell 60 where 99.99+ pure lithium may be collected at the cathode.

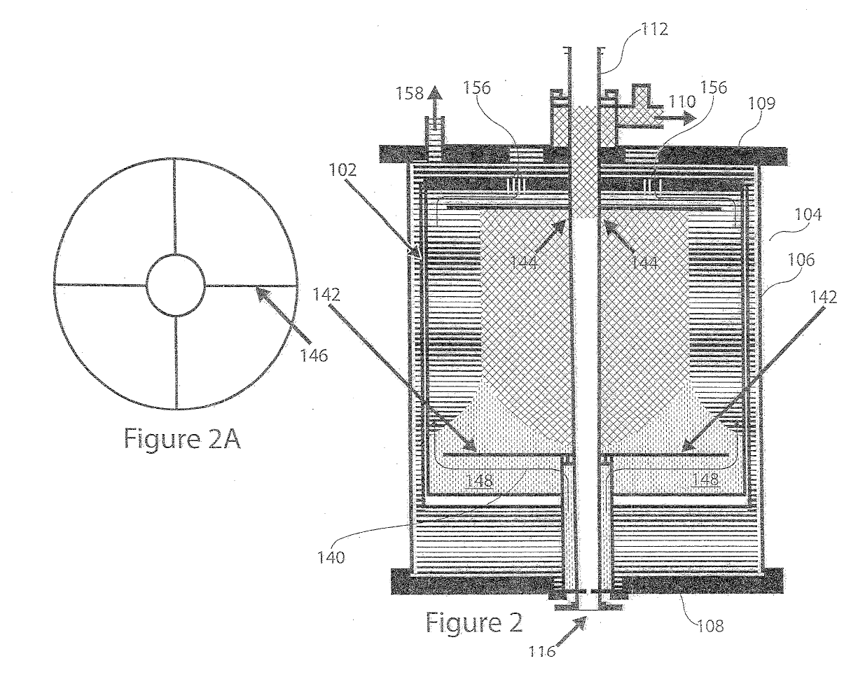

Referring in particular to FIG. 2, there is shown centrifugal separator 100A. However, centrifugal separator 100B is essentially the same. Centrifugal separator 100A, which is similar to the centrifugal separator described in our prior U.S. Pat. No. 6,440,054, comprises a rotatable cylinder 102 in the shape of a vertical right cylinder contained in a housing 104 having vertical side wall 106 bottom wall 108 and top wall 109. A vertical drive shaft 112 is suspended at the upper end of housing 104 by an upper thrust bearing. Centrifugal separator 100A has an inlet 116 for input of an organic/aqueous mixed phase, i.e., from conduit 34A. The solution enters the central opening (orifice) 140 of the rotating cylinder 102. The dispersion entering central orifice 140, gets deflected towards the outside wall of the cylinder by a horizontal deflecting baffle 142 provided close to the entrance. Referring also to FIG. 2A, unlike the centrifugal separator described in aforesaid U.S. Pat. No. 6,440,054, the mixing box at the bottom of the centrifugal separator is eliminated, and the upper end of rotating cylinder 102 provided with a plurality of vertical baffles 146 which create several chambers ranging from 4 to 8. A preferred embodiment, has four (4) chambers. The rotating cylinder 102 imparts to the liquid a practically rigid body rotation. The inner surface of the rotating liquid has almost a vertical shape because of high ‘g’ except a small parabolic portion adjacent the bottom. The dispersion entering at the bottom region 148 gets separated as it moves upwards. The rate of separation depends upon the droplet size distribution, their settling velocities under the centrifugal action (rΩ2), where r is the radius of the bowl/chamber and Ω is the rotation speed), densities, viscosities and coalescing behavior of the two phases. For complete separation, adequate height needs to be provided for a given level of (rΩ2). Inside the bowl/chamber the solution is separated into two phases—a light phase, which is discharged through the ports 144 and exits the unit through the top port 110, and a heavy phase which is discharged through outlet ports 156 and leaves the unit through outlet 158. The heavy phase outlet ports 156 have variable positions which are selected and changed according to the relative densities of the heavy and light phases and the relative volumes of each phase within the centrifugal separator 100A.

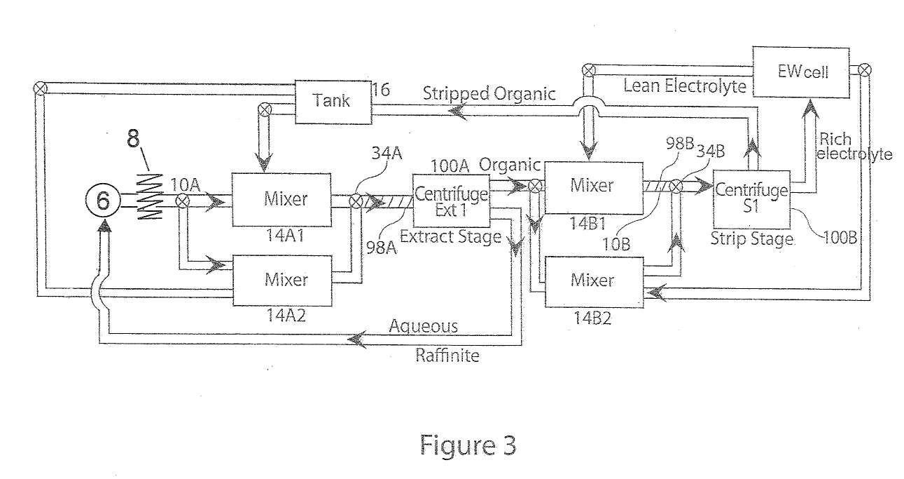

FIG. 3 shows an alternative embodiment of the invention. The FIG. 3 embodiment includes two mixing vessels 14A1 and 14A2, and 14B1 and 14B2 for both the extract stage as well as the strip stage connected through valving and conduits 10A, 10B, 34A, 34B, so that one mixing vessel may remain in service, while the other mixing vessel is taken off line for maintenance or cleaning.

After being stripped of lithium, the brine may be returned to the geothermal reservoir via reinjection wells.

The present invention provides various advantages over prior art processes. For one, the system is closed. Thus, loss of the liquid ion exchange reagent and other organic solvents, i.e. due to evaporation is avoided. Also, by passing the organic phase through finely divided media or frits, and a permeable body before the organic phase is mixed with the aqueous brine solution, a micro dispersion of the organic phase is formed in the aqueous brine solution. Thus, less organic liquid ion exchange reagent solvent is needed in the overall process. Also, higher throughput may be achieved with smaller equipment overall, thus adding to equipment savings, as well as operational savings.

Also, from studies and tests we found that entrainment of the organic phase in the aqueous is generated in mixing step and not influenced by the separator. The quantity of entrainment is substantially affected by air ingestion. Using the hollow permeable body mixing apparatus as above described greatly reduces the possibility of air entrainment in the liquid and thus improves separation in the downstream separator (any separator for that matter).

Also, if air is excluded from the dispersion in the mixer, then organic-in-aqueous entrainment is minimized and aqueous-in-organic entrainment essentially reduced essentially to undetectable levels. Thus, our mixing apparatus as above described allows for a reduction, if not essentially elimination of air entrainment in the liquid thus reducing entrainment of one phase in the other phase. Conventional prior art mixing devices cannot achieve this since by design conventional mixing systems are exposed to the atmosphere and draw air into the liquid.

Various changes may be made in the above invention without the departing from the spirit and scope thereof For example, the lithium-containing brines may be concentrated for example, by evaporating some of the water, before mixing with the organic liquid extractant. Also, while a kerosene having a flash point above 67° C. is the preferred diluent, other liquid hydrocarbon mixtures and other organic compound mixtures having a flash point above about 67° C., advantageously may be used. And, while geothermal brine sources have been described, other brine sources such as from mining sources, oil field and relict hydrothermal brines, and brines from intercontinental salt lakes also advantageously may be used as a feed brine. And, other metals including, but not limited to zinc, nickel, cobalt, uranium, lead, silver and manganese, rare earth elements such as Neodymium (Nd), Yttrium (Y), Cerium (Ce), Praseodymium (Pr), Terbrium (Tb), Europium (Eu), Scandium (Sc), Ytterbium (Yb) and Lanthanum (La), and various alkali and alkaline earth metals which also are known to be present in geothermal brines also may be recovered using appropriate extractants, e.g. as above described, and electrowinning at appropriate potentials. Additionally, metals of interest may be collected using spray-drying techniques. Still other changes are possible without departing from the scope and spirit of the invention.

1. A method for extracting an alkali or alkaline earth metal or other metal from a source of an aqueous brine containing said alkali or alkaline earth metal or other metal comprising the steps of:
feeding the aqueous brine containing said alkali or alkaline earth metal or other metal and an immiscible organic liquid ion exchange reagent plus a high flash point diluent having a capacity to selectively extract said metal, to a first mixing vessel, wherein the mixing vessel comprises a first elongate housing having an inlet adjacent one end and an outlet adjacent the other end, and a permeable body coaxially disposed within the housing;
passing the mixture from the first mixing vessel to a first centrifuge wherein the mixture is separated into a light organic phase which is mixed in a second mixer with lean electrolyte from a downstream electrowinning stage, and a heavy aqueous raffinate phase which is returned to the source; and
passing the mixture from the second mixer to a second centrifuge where the mixture is separated to an aqueous raffinate phase, which is passed to an electrowinning cell wherein said metal is removed from the aqueous raffinate by electrowinning, and a lean electrolyte which is passed to the second mixer.

2. The method of claim 1, wherein the first and the second mixers have mixing channels substantially in the shape of a helix.

3. The method according to claim 1, the first and second mixers include internal baffles formed of a series of elongated segments formed end-to-end.

4. The method according to claim 1, wherein the permeable body has pores in the range of 0.2 to 400 microns, preferably 20 to 200 microns, more preferably 60 to 100 microns.

5. The method according to claim 1, wherein permeable body comprises an elongate cylinder, in shape.

6. The method according to claim 1, wherein the first and second mixers are sized and shaped to provide a travel or residence time between the first and second mixing devices and the first and second centrifuges of 5-120 seconds, preferably 20-60 seconds, more preferably 35-45 seconds.

7. The method according to claim 1, wherein the metal comprises lithium and the immiscible organic liquid ion exchange reagent is selected from the group consisting of a tert-butyl benzo-12-crown-4 ether in a short chain linear polymer (SCP), and a halogenated β-diketone.

8. The method of claim 1, wherein the metal comprises lithium and the immiscible organic liquid ion exchange reagent is selected from a group consisting of a primary, tertiary, or quaternary amine, Mono-2-ethyl hexyl phosphoric acid (D2EHPA), a phosphinic acid, a phosphonic acid, Tributyl phosphate, a versatic acid, and an oxime or hydroxyl oxime ion exchange reagent.

9. The method of claim 1, wherein the metal comprises lithium and the immiscible organic liquid ion exchange reagent is selected from the group consisting of a hydroxyl oxime, a diester of pyridine, dicarboxylic acid, tri-n-butyl phosphate, and tri-octyl phosphine oxide.

10. The method of claim 1, including the step of returning the aqueous raffinate from the first centrifuge to the source.

11. The method of claim 1, wherein the source is selected from the group consisting of a geothermal brine, a brine from a mining source, an oil field brine, a relict hydrothermal brine, or an intercontinental salt lake.

12. The method of claim 1, including the step of prefiltering the brine to remove silica.

13. The method of claim 1, wherein the source comprises a geothermal reservoir well and the aqueous raffinate is returned to the geothermal reservoirs by injection into the well.

14. The method of claim 1, wherein the other metal is selected from the group consisting of zinc, nickel, cobalt, uranium, lead, silver, manganese and a rare earth element selected from the group consisting of Neodymium (Nd), Yttrium (Y), Cerium (Ce), Praseodymium (Pr), Terbium(Tb), Europium (Eu), Scandium (Sc), Ytterbium (Yb) and Lanthanum (La).
